(19) United States
(12) Patent Application Publication
(10) Pub. No.: US 2006/0150150 A1
(43) Pub. Date: Jul. 6, 2006

(54) Editor support for modifying generated source code

(75) Inventors: Alpana Tiwari, Yorktown Heights, NY (US); Richard J. Cardone, Mahopac, NY (US); Danny Soroker, Larchmont, NY (US)

Correspondence Address: MICHAEL J. BUCHENHORNER, ESQ;HOLLAND & KNIGHT, 701 BRICKELL AVENUE, MIAMI, FL, 33131, US

(73) Assignee: International Business Machines Corporation

(21) Appl. No.: 11/030,430

(22) Filed: Jan. 6, 2005

(51) Int. Cl. G06F 9/44

(52) U.S. Cl. 717/110

(57) ABSTRACT

A method for editing source code containing automatically generated source code includes detecting the automatically generated source code. The method further includes receiving modifications made by a user to the automatically generated source code and storing an indicator that the automatically generated source code has been modified by the user. In one alternative, the method further includes regenerating the automatically generated source code while preserving the modifications made by the user to the automatically generated source code.

### CROSS-REFERENCE TO RELATED APPLICATIONS

Not Applicable.

### STATEMENT REGARDING FEDERALLY SPONSORED-RESEARCH OR DEVELOPMENT

Not Applicable.

### INCORPORATION BY REFERENCE OF MATERIAL SUBMITTED ON A COMPACT DISC

Not Applicable.

### FIELD OF THE INVENTION

The invention disclosed broadly relates to the field of computer programming and more particularly relates to the field of computer programming involving automatically generated source code.

### BACKGROUND OF THE INVENTION

Source code generators have been an integral part of software development for many years. These generators are programs whose output is programming or specification language text, i.e., text in a computer language that was designed for direct editing by human developers. Some of the earliest source code generators were parser generators, such as Lex (a lexical analyzer generator for user specified input languages) and YACC (Yet Another Compiler Compiler—a parser generator found on most Unix systems), which took a language specification as input and generated a lexer and parser for that language as output. Today, there are numerous parser generators in existence, including JavaCC (Java Compiler Compiler—a parser generator for use with Java applications) and ANTLR (Another Tool for Language Recognition—a parser generator in the Purdue compiler-construction tool set). Source code generators, however, come in many varieties, including generators that take UML (Unified Modeling Language), XML (extensible Markup Language) schemas, or proprietary application specifications as input and generate Java, C++ and other source code artifacts as output.

Source code generators must address the issue of how to handle post-generation changes to generated source code. This issue only arises when the source code must be regenerated, such as when the input specification to the generator changes. The simplest solution is not to recognize any changes to generated source upon regeneration, which means that all changes to generated source code are lost when the source code is regenerated. Generators like JavaCC, however, allow users to include handwritten code in the input specification. This handwritten code is then outputted along with generated source code and, thus, preserved during regeneration. Other parser generators, like EMF (Eclipse Modeling Framework—a modeling framework and code generation facility for building tools and other applications based on a structured data model), go a step further by providing some support for post-generation changes to generated source code. EMF indicates with an annotation in a generated Java method's JavaDoc comment that the method was automatically generated. If a method is altered after generation by a user, the user may remove this annotation to preserve any manually inserted changes when EMF automatically regenerates the source code.

None of the current approaches to this problem, however, provide active guidance to the computer programmer when he is writing the source code. Neither do any of the approaches automatically detect user-inserted source code and preserve it during automatic regeneration of the source code. Further, there is currently no solution to the problems associated with a computer programmer editing source code that is automatically generated and should not be edited.

Therefore, there is a need to overcome problems with the prior art as discussed above, and more particularly a need to make the process of developing source code involving automatically generated code more efficient.

### SUMMARY OF THE INVENTION

Briefly, according to an embodiment of the invention, a method for editing automatically generated source code includes detecting the automatically generated source code. The method further includes receiving modifications made by a user to the automatically generated source code and storing an indicator that the automatically generated source code has been modified by the user. In another embodiment, the method further includes regenerating the automatically generated source code while preserving the modifications made by the user to the automatically generated source code.

In another embodiment of the present invention, an information processing system for editing automatically generated source code is disclosed. The information processing system includes a processor configured for detecting the automatically generated source code and an editor for receiving modifications made by a user to the automatically generated source code. The information processing system further includes a memory for storing an indicator that the automatically generated source code has been modified by the user. In another embodiment, the information processing system further includes a source code generator for regenerating the automatically generated source code while preserving the modifications made by the user to the automatically generated source code.

In yet another embodiment of the present invention, a computer readable medium including computer instructions for editing automatically generated source code is disclosed. The computer instructions includes instructions for detecting the automatically generated source code and receiving modifications made by a user to the automatically generated source code. The computer instructions further include instructions for storing an indicator that the automatically generated source code has been modified by the user. In another embodiment, the computer instructions further include instructions for regenerating the automatically generated source code while preserving the modifications made by the user to the automatically generated source code.

### BRIEF DESCRIPTION OF THE DRAWINGS

The subject matter, which is regarded as the invention, is particularly pointed out and distinctly claimed in the claims at the conclusion of the specification. The foregoing and other features and also the advantages of the invention will be apparent from the following detailed description taken in conjunction with the accompanying drawings. Additionally, the left-most digit of a reference number identifies the drawing in which the reference number first appears.

FIG. 1 is an illustration of automatically generated source code, in one embodiment of the present invention.

FIG. 2 is another illustration of automatically generated source code, in one embodiment of the present invention.

FIG. 3 is a flow chart depicting the control flow of the interactive editor support process, in one embodiment of the present invention.

FIG. 4 is a block diagram depicting the automatic source code generation process involving internal indications, in one embodiment of the present invention.

FIG. 5 is a block diagram depicting the automatic source code generation process involving external indications, in one embodiment of the present invention.

FIG. 6 is a high level block diagram showing an information processing system useful for implementing one embodiment of the present invention.

### DETAILED DESCRIPTION

As explained more fully above, source code generators can be used to generate some or all of the source code for a software application. Once generated, this source code is compiled, along with any user modifications to it, to build the complete software application. The “round-trip problem” of software development is the problem of preserving user modifications to automatically generated source code when the source code is re-generated. To help address this problem, source code generators often indicate within the source code which fragments are generated, using stylized comments or some other mechanism. The fragments marked “automatically generated” will be automatically re-generated, so the user should avoid modifying these portions of source code. Thus, it is the user's responsibility to adhere to these indications, either by avoiding modification of certain source code or by removing the stylized comments.

The present invention specifies how a source code editor program can assist developers in managing automatically generated source code in cases like EMF, where the generator provides some support for post-generation changes to the automatically generated source code. There are no known solutions to this problem at this time.

The present invention provides tooling support to help manage user modifications to automatically-generated source code. In particular, users typically modify source code with an editor program that is often part of in an Integrated Development Environment (IDE). The present invention enhances such editors so as to distinguish and manage manually modified source code and automatically generated source code. The present invention includes multiple policies for editor program behavior, such as issuing a warning when users attempt to modify an automatically generated source code fragment, prohibiting user modifications to automatically generated source code fragments and automatically marking (or un-marking) an automatically generated source code fragment that has been user modified, so that it will not be overwritten upon re-generation. Thus, the present invention allows for source code editor programs and source code generators to cooperate to manage a mixture of manually (i.e., user) produced and automatically produced source code.

The present invention is supported by existing technology in the area of editors and IDEs. Existing IDEs, such as Eclipse or Microsoft Visual Studio NET, employ intelligent source code editors that respond intelligently to user actions depending on the mouse pointer or text cursor position. For example, in the EMF Java editor, when the mouse pointer hovers over a Java element (such as a class or method name), the editor can automatically display a flyover with the documentation of that element. In another example, when the text cursor is placed on a Java element the editor can highlight the entire element and all its occurrences in the file.

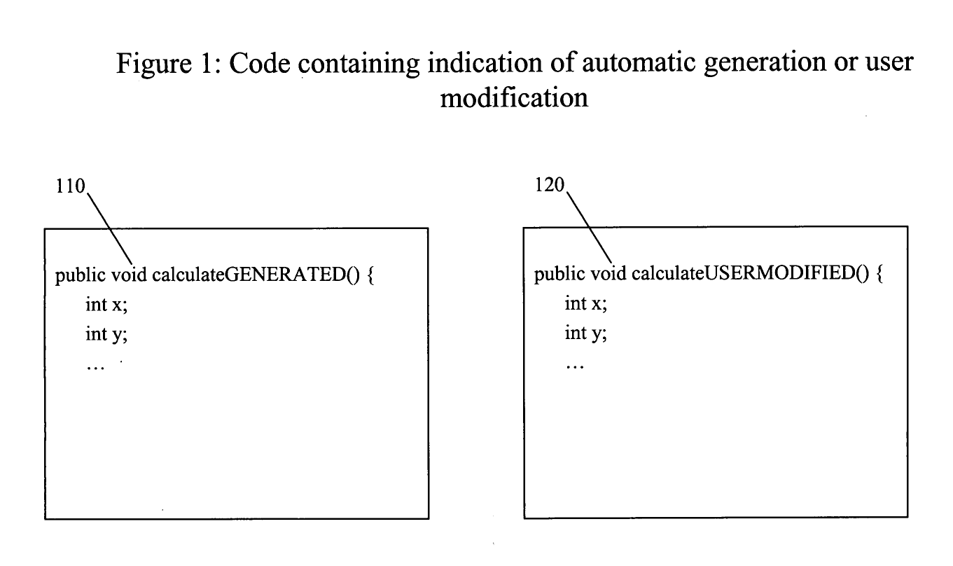

FIG. 1 is an illustration of automatically generated source code, in one embodiment of the present invention. FIG. 1 shows source code snippets including indications of automatically generated source code and user modified source code. Section 110 of the source code shows a method name with the suffix “GENERATED” indicating that the source code of the method is automatically generated. Section 120 of the source code shows the same method as section 110 renamed with the suffix “GENERATED” removed, and the suffix “USERMODIFIED” appended, to indicate that a user has modified the source code. Sections 110 and 120 of the source code show a visual method (i.e., the use of a suffix appended to a method) for indicating to a programmer that a certain fragment of source code is either automatically generated or automatically generated but modified by a user. FIG. 1 shows that section 120 includes an extra variable not present in section 110.

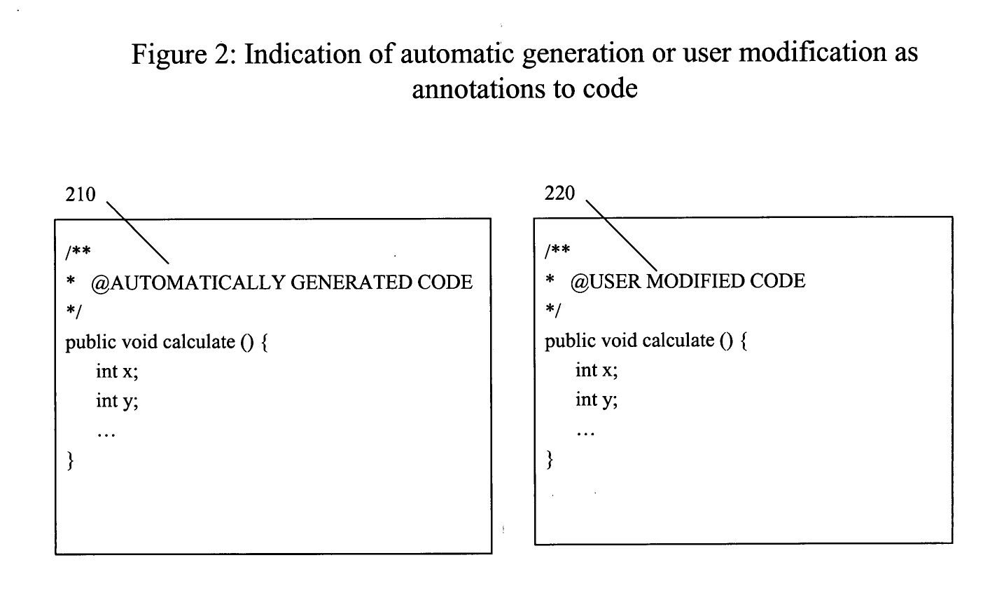

FIG. 2 is another illustration of automatically generated source code, in one embodiment of the present invention. FIG. 2 shows source code snippets including indications of source code that is automatically generated and user modified source code using annotations or comments. Section 210 of the source code shows a method with the annotation “@AUTOMATICALLY GENERATED CODE” in the comments preceding the pertinent source code. Section 220 of the source code shows the same method as section 210 with the annotation “@USER MODIFIED CODE” in the comments to indicate that a user has modified the automatically generated source code. Sections 210 and 220 of the source code show a visual method (i.e., the use of text in comments) for indicating to a programmer that a certain fragment of source code is either automatically generated or automatically generated but modified by a user. FIG. 2 shows that section 220 includes an extra variable not present in section 210.

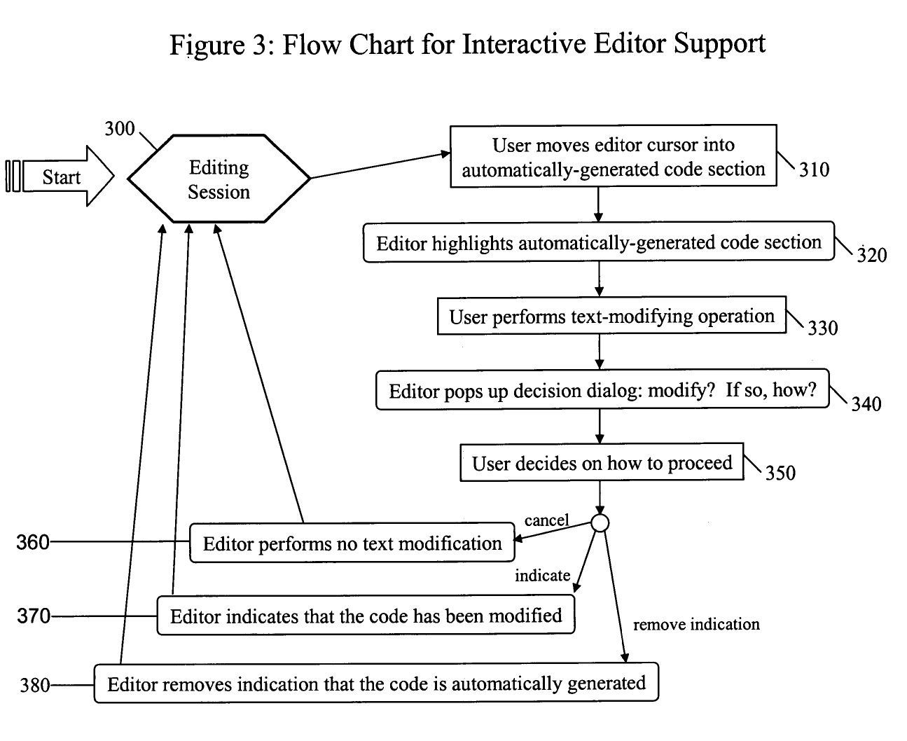

FIG. 3 is a flow chart depicting the control flow of the interactive editor support process, in one embodiment of the present invention. FIG. 3 shows a flow chart that implements interactive editor support for modifying automatically generated source code. The rectangles represent user actions, and the rounded rectangles represent editor actions. The control flow of FIG. 3 begins with a source code editing session in step 300.

During a source code editing session 300, the user performs an action (such as a mouse or keyboard click), in step 310, which causes the cursor to move into an automatically generated source code section. As a result, the editor, in step 320, indicates to the user that the source code under the cursor or mouse pointer is an automatically generated source code section. In one embodiment of the present invention, the editor provides a visual indication that the source code is automatically generated source code by highlighting the source code section 320, displaying it in a different color or surrounding it with a different color or graphic.

Subsequently, in step 330, when the user performs an editing operation (such as a keyboard press or a cut/paste operation) upon the highlighted source code section, the editor responds in step 340 by presenting the user with options. For example, in step 340, the editor may display or pop up a dialog or other interface asking the user how to proceed. The dialog or interface may ask the user to choose between several options, including 1) whether the user desires to cancel any modifications made to the highlighted source code section, 2) whether the user desires to effectuate any changes made to the highlighted source code section and then brand the source code section as “user modified,” and 3) whether the user desires to remove any visual indications that the highlighted source code section is automatically generated. There may be other options for the user to select.

In the event the user desires to cancel any modifications made to the highlighted source code section, in step 360 the editor cancels any modifications made by the user to the highlighted source code section. In the event the user desires to effectuate any changes made to the highlighted source code section and then brand the source code section as “user modified,” in step 370 the editor effectuates the changes made to the highlighted source code section and then brands the source code section as “user modified.” In the event the user desires to remove any visual indications that the highlighted source code section is automatically generated, in step 380 the editor removes any visual indications that the highlighted source code section is automatically generated. In any case, following these interactions, the editing session resumes in step 300.

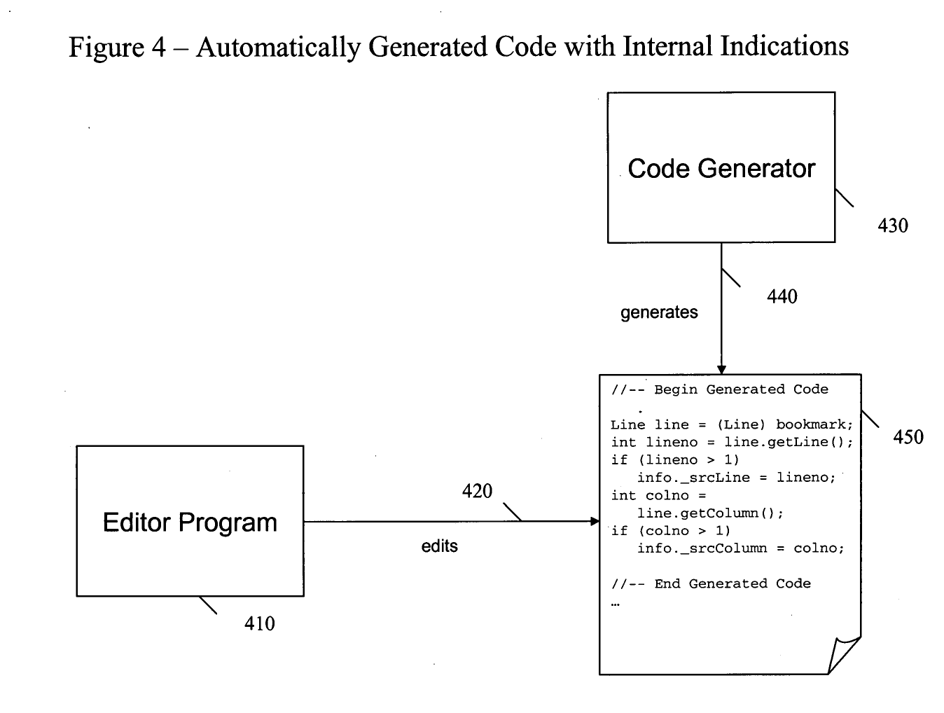

FIG. 4 is a block diagram depicting the automatic source code generation process involving internal indications, in one embodiment of the present invention. In FIG. 4, source code generator 430 outputs source code artifact 450 through a generation process 440. Source code generator 430 can be, for example, a compiler or other IDE, such as the Microsoft C++ Visual Studio, that automatically generates source code for a software application.

The source code 450 resides in a file that can also contain source code not generated by source code generator 430. For example, a user, such as a computer programmer, can perform an editing function 420 using an editor program 410 to modify the source code 450. The file of source code 450 can be, for example, a text file having a “.c” or “.cc” extension for a C or C++ programming language file or a text file having a “jav” or “.java”. extension for a Java programming language file. Editor program 410 can be, for example, a text editor or a programming language editor component of an IDE, such as the Microsoft C++ Visual Studio or the Microsoft J++ Visual Studio or CodeWarrior.

In one embodiment of the present invention, source code artifact 450 is created by source code generator 430 and then modified by a user utilizing editor program 410. In another embodiment, source code artifact 450 is created using editor program 410 and then modified by source code generator 430. In FIG. 4, the distinction between (1) source code generated by source code generator 430 and (2) source code created or modified using editor program 410 is indicated by annotations embedded in source code artifact 450, such as annotations described in more detail with reference to FIGS. 1 and 2 above. These annotations are automatically inserted by the editor program 410 during or after the editing procedure 420.

There is no limit to the number of times that a code generator or an editor program can modify a source code artifact. Further, there can be more than one editor program that can modify a source code artifact and there can be more than one code generator that can change a source code artifact.

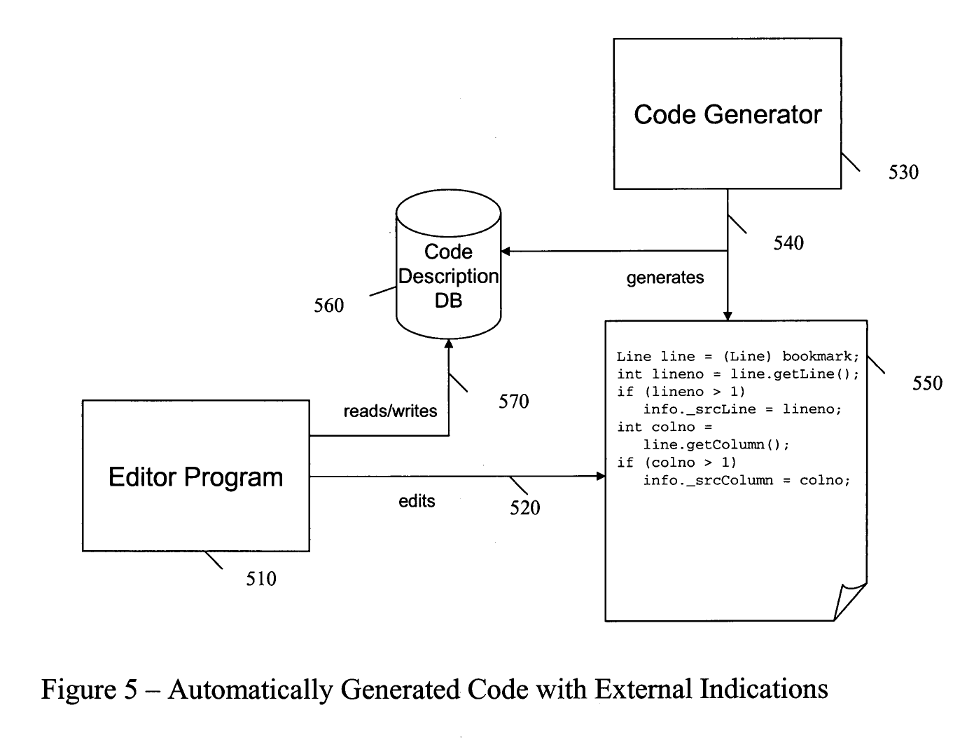

FIG. 5 is a block diagram depicting the automatic source code generation process involving external indications, in one embodiment of the present invention. In FIG. 5, source code generator 530 outputs source code artifact 550 and entries in source code description database 560 through the generation process 540. Source code generator 530 can be a generator as described for source code generator 430 above. The source code artifact 550 resides in a file that can also contain source code not generated by source code generator 530. The file of source code artifact 550 can be the a file similar to that of source code artifact 450. Source code description database 560 can be any commercially available database and database management system.

Source code description database 560 contains information necessary to identify at least three categories of source code. The first category of source code includes those parts of a file that contain source code generated by source code generator 530, the second category includes those parts of a file that contain source code generated by source code generator 530 that have been modified by a user utilizing editor program 510, and the third category includes those parts of a file that contain source code not generated by source code generator 530.

In one embodiment of the present invention, the entries in source code description database 560 include ordered pairs that indicate a line number in the source code file and a source code category indicator. For example, if line 5 of source code artifact 550 belongs to the second category of source code, the ordered pair would be “5, 2” wherein the number five represents line number five and the number two represents the second category of source code.

In another embodiment of the present invention, the entries in source code description database 560 include a list of number trios that indicate a start point and end point in the source code file and a source code category indicator. Start points and end points represent the sequential number of a character in the source code file. For example, if the first twenty characters of a source code artifact 550 belong to the second category of source code, the number trio would be “1, 20, 2” wherein the number one represents the first character in the source code file, the number twenty represents the twentieth character, and the number two represents the second category of source code.

In another embodiment of the present invention, the entries in source code description database 560 can include metadata for each source code category. For example, the second source code category (directed to automatically generated but user modified source code) can include a timestamp that indicates how long a user modification shall be effective. The timestamp can be a first date indicator that indicates when the user modification was implemented and a second data indicator that indicates when the effectiveness of the user modification expires. Upon expiration of the user modification, according to the timestamp, the user modification to the source code is deleted, erased or otherwise undone in order to restore the source code to the state it held before the user modification took place. Alternatively, after the expiration of the user modification, according to the timestamp, the user modification to the automatically generated source code may be erased the next time the source is automatically generated.

The code generator 530 can simultaneously generate code for the source code file 550 and the corresponding entries in the code description database 560 via the red/write function 560. The read/write function 560 can generate the entries in source code description database 560, including ordered pairs.

A user or computer programmer can perform editing function 520 using editor program 510 to modify the source code in source code file 550, simultaneously creating or modifying entries in source code description database 560 as defined in read/write function 570. In one embodiment of the present invention, source code generator 530 simultaneously creates source code artifact 550 and the corresponding entries in source code description database 560 that describe the new source code artifact.

In one embodiment of the present invention, source code artifact 550 is created by source code generator 530 and then modified by a user utilizing editor program 510. In another embodiment, source code artifact 550 is created using editor program 510 and then modified by source code generator 530. After generation or regeneration of source code by the source code generator 530, a user or computer programmer using editor program 510 can simultaneously modify source code artifact 550 and entries in source code description database 560 that describe the state of the modified source code artifact 550. In another embodiment of the present invention, a user or computer programmer using editor program 510 can simultaneously create source code artifact 550 and the necessary entries in source code description database 560 that describe the new source code artifact 550. Afterwards, source code generator 530 can simultaneously modify source code artifact 550 and the corresponding entries in source code description database 560 that describe the state of the modified source code artifact 550.

It should be noted that the source code category of any source code fragment can be changed to any other source code category. For example, source code that belongs to the first category, automatically generated, can be changed to the second category, automatically generated but user-modified, when a user modifies the course code fragment. In another example, source code that belongs to the first category, automatically generated, can be changed to the third category when, not automatically generated, when a user modifies the course code fragment. The change can occur upon a user's request or automatically in response to a user's action.

It should also be noted that although only three categories of source code are described above, the present invention supports any number of different source code categories, any of which can be modified.

There is no limit to the number of times that a code generator or an editor program can modify a source code artifact or the corresponding data in the source code description database. Further, there can be more than one editor program that can modify a source code artifact and the corresponding data in the source code description database. In addition, there can be more than one code generator that can modify a source code artifact and the corresponding data in the source code description database.

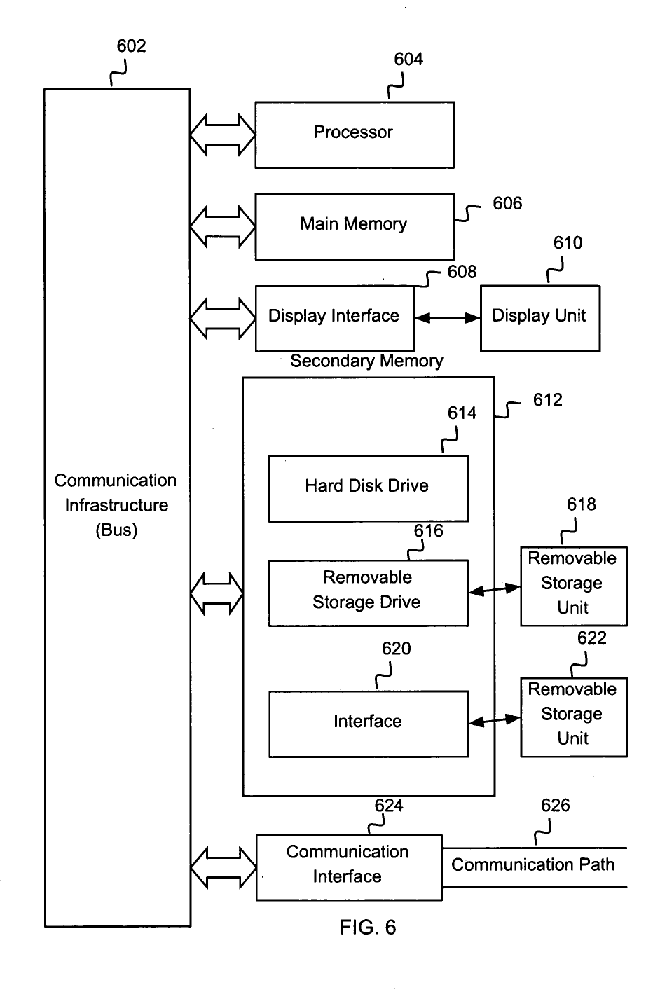

In an embodiment of the present invention, the computer system implementing the features of the present invention is one or more Personal Computers (PCs) (e.g., IBM or compatible PC workstations running the Microsoft Windows operating system, Macintosh computers running the Mac OS operating system, or equivalent), Personal Digital Assistants (PDAs), hand held computers, palm top computers, smart phones, game consoles or any other information processing devices. In another embodiment, the computer system is a server system (e.g., SUN Ultra workstations running the SunOS operating system or IBM RS/6000 workstations and servers running the AIX operating system). Such as computer system is described in greater detail below with reference to FIG. 6.

The present invention can be realized in hardware, software, or a combination of hardware and software. A system according to a preferred embodiment of the present invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general-purpose computer system with a computer program that, when being loaded and executed, controls the computer system such that it carries out the methods described herein.

An embodiment of the present invention can also be embedded in a computer program product, which comprises all the features enabling the implementation of the methods described herein, and which—when loaded in a computer system—is able to carry out these methods. Computer program means or computer program in the present context mean any expression, in any language, code or notation, of a set of instructions intended to cause a system having an information processing capability to perform a particular function either directly or after either or both of the following: a) conversion to another language, code or, notation; and b) reproduction in a different material form.

A computer system may include, inter alia, one or more computers and at least a computer readable medium, allowing a computer system, to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer readable medium may include, for example, volatile storage such as RAM, buffers, cache memory, and network circuits. Furthermore, the computer readable medium may comprise computer readable information in a transitory state medium such as a network link and/or a network interface, including a wired network or a wireless network, that allow a computer system to read such computer readable information.

FIG. 6 is a high level block diagram showing an information processing system useful for implementing one embodiment of the present invention. The computer system includes one or more processors, such as processor 604. The processor 604 is connected to a communication infrastructure 602 (e.g., a communications bus, cross-over bar, or network). Various software embodiments are described in terms of this exemplary computer system. After reading this description, it will become apparent to a person of ordinary skill in the relevant art(s) how to implement the invention using other computer systems and/or computer architectures.

The computer system can include a display interface 608 that forwards graphics, text, and other data from the communication infrastructure 602 (or from a frame buffer not shown) for display on the display unit 610. The computer system also includes a main memory 606, preferably random access memory (RAM), and may also include a secondary memory 612. The secondary memory 612 may include, for example, a hard disk drive 614 and/or a removable storage drive 616, representing a floppy disk drive, a magnetic tape drive, an optical disk drive, etc. The removable storage drive 616 reads from and/or writes to a removable storage unit 618 in a manner well known to those having ordinary skill in the art. Removable storage unit 618, represents a floppy disk, a compact disc, magnetic tape, optical disk, etc. which is read by and written to by removable storage drive 616. As will be appreciated, the removable storage unit 618 includes a computer readable medium having stored therein computer software and/or data.

In alternative embodiments, the secondary memory 612 may include other similar means for allowing computer programs or other instructions to be loaded into the computer system. Such means may include, for example, a removable storage unit 622 and an interface 620. Examples of such may include a program cartridge and cartridge interface (such as that found in video game devices), a removable memory chip (such as an EPROM, or PROM) and associated socket, and other removable storage units 622 and interfaces 620 which allow software and data to be transferred from the removable storage unit 622 to the computer system.

The computer system may also include a communications interface 624. Communications interface 624 allows software and data to be transferred between the computer system and external devices. Examples of communications interface 624 may include a modem, a network interface (such as an Ethernet card), a communications port, a PCMCIA slot and card, etc. Software and data transferred via communications interface 624 are in the form of signals which may be, for example, electronic, electromagnetic, optical, or other signals capable of being received by communications interface 624. These signals are provided to communications interface 624 via a communications path (i.e., channel) 626. This channel 626 carries signals and may be implemented using wire or cable, fiber optics, a phone line, a cellular phone link, an RF link, and/or other communications channels.

In this document, the terms “computer program medium,” “computer usable medium,” and “computer readable medium” are used to generally refer to media such as main memory 606 and secondary memory 612, removable storage drive 616, a hard disk installed in hard disk drive 614, and signals. These computer program products are means for providing software to the computer system. The computer readable medium allows the computer system to read data, instructions, messages or message packets, and other computer readable information from the computer readable medium.

Computer programs (also called computer control logic) are stored in main memory 606 and/or secondary memory 612. Computer programs may also be received via communications interface 624. Such computer programs, when executed, enable the computer system to perform the features of the present invention as discussed herein. In particular, the computer programs, when executed, enable the processor 604 to perform the features of the computer system. Accordingly, such computer programs represent controllers of the computer system.

What has been shown and discussed is a highly-simplified depiction of a programmable computer apparatus. Those skilled in the art will appreciate that other low-level components and connections are required in any practical application of a computer apparatus.

Therefore, while there has been described what is presently considered to be the preferred embodiment, it will be understood by those skilled in the art that other modifications can be made within the spirit of the invention.

What is claimed is:

1. A method for editing source code containing automatically generated source code, the method comprising:
detecting the automatically generated source code;
receiving modifications made by a user to the automatically generated source code; and
providing an indicator that the automatically generated source code has been modified by the user.

2. The method of claim 1, the method further comprising:
regenerating the automatically generated source code while preserving the modifications made by the user to the automatically generated source code.

3. The method of claim 1, wherein the element of detecting comprises:
detecting in the source code a text indicator that code is automatically generated.

4. The method of claim 1, wherein the element of detecting comprises:
detecting an indicator that code is automatically generated, the indicator being stored in a database.

5. The method of claim 1, wherein the element of receiving comprises:
receiving modifications made by a user to the automatically generated source code; and
prohibiting the modifications made by the user to the automatically generated source code.

6. The method of claim 1, wherein the element of receiving comprises:
receiving modifications made by a user to the automatically generated source code; and
visually indicating to the user that modifications to the automatically generated source code have been made.

7. The method of claim 1, wherein the element of providing comprises:
inserting into the source code a text indicator of the modifications made by the user to the automatically generated source code.

8. The method of claim 1, wherein the element of providing comprises:
removing the text indicator in the source code that code is automatically generated.

9. The method of claim 1, wherein the element of providing comprises:
generating an indicator of the modifications made by the user to the automatically generated source code; and
storing the indicator in a database.

10. The method of claim 1, wherein the element of providing comprises:
removing the indicator stored in a database that code is automatically generated.

11. The method of claim 1, wherein the element of receiving comprises:
receiving modifications made by a user to the automatically generated source code; and
allowing the user to choose whether to effectuate the modifications made by the user to the automatically generated source code.

12. The method of claim 1, wherein the element of receiving comprises:
receiving modifications made by a user to the automatically generated source code; and
generating an indicator of the modifications made by the user to the automatically generated source code, wherein the indicator includes additional information about the user modification.

13. An information processing system for editing source code containing automatically generated source code, comprising:
a processor configured for detecting the automatically generated source code;
an editor for receiving modifications made by a user to the automatically generated source code; and
a memory for storing an indicator that the automatically generated source code has been modified by the user.

14. The information processing system of claim 13, further comprising:
a source code generator for regenerating the automatically generated source code while preserving the modifications made by the user to the automatically generated source code.

15. The information processing system of claim 13, wherein the processor is further configured for:
detecting in the source code a text indicator that code is automatically generated.

16. The information processing system of claim 13, wherein the processor is further configured for:
detecting an indicator that code is automatically generated, the indicator being stored in memory.

17. The information processing system of claim 13, wherein the editor is further configured for:
inserting into the source code a text indicator of the modifications made by the user to the automatically generated source code.

18. The information processing system of claim 17, wherein the editor is further configured for:
receiving modifications made by the user to the automatically generated source code; and
removing the text indicator in the source code that code is automatically generated.

19. The information processing system of claim 13, wherein the editor is further configured for:
generating an indicator of the modifications made by the user to the automatically generated source code; and
storing the indicator in the memory.

20. A computer readable medium including computer instructions for editing source code containing automatically generated source code, the computer instructions including instructions for:
detecting the automatically generated source code;
receiving modifications made by a user to the automatically generated source code; and
storing an indicator that the automatically generated source code has been modified by the user.
